(19) United States
(12) Patent Application Publication
(10) Pub. No.: US 2014/0086702 A1
(43) Pub. Date: Mar. 27, 2014

(54) NUT

(71) Applicants: SUMITOMO FORESTRY CO., LTD., Tokyo (JP); KANAI CO., LTD., Tokyo (JP)

(72) Inventors: Junichi IMAI, Chiyoda-ku (JP); Hiroki NAKASHIMA, Chiyoda-ku (JP); Kunio KANAI, Adachi-ku (JP); Yasufumi USHIO, Adachi-ku (JP)

(73) Assignees: KANAI CO., LTD., Tokyo (JP); SUMITOMO FORESTRY CO., LTD., Tokyo (JP)

(21) Appl. No.: 13/785,830

(22) Filed: Mar. 5, 2013

(30) Foreign Application Priority Data
Sep. 25, 2012 (JP) 2012-210428

(51) Int. Cl. F16B 39/28

(52) U.S. Cl. CPC F16B 39/28
USPC 411/190

(57) ABSTRACT

A nut comprises a metal member including a nut body having an internally threaded portion formed therein and an extension formed on one end of the nut body so as to surround an opening of the internally threaded portion, the metal member being subjected to surface treatment; and a ring member made of a synthetic resin, having an outer peripheral portion united with an inner side of the extension and having a ring inner diameter substantially equal to a minor diameter of the internally threaded portion, the outer peripheral portion being united with the inner side of the extension by insert-molding using the metal member as an insert; wherein the extension has at least one recess formed in an inner portion, and the outer peripheral portion has a rotation-preventing portion fit into the at least one recess, the rotation-preventing portion being formed by the insert molding.

### FIELD OF INVENTION

The present invention relates to an improvement in a nut having an anti-loosening function.

### BACKGROUND OF INVENTION

A locking nut has been known wherein a tightening sheet made of polyamide is placed in a cylindrical portion communicating with an internally threaded bore formed in a main body forming a nut, followed by bending an upper edge of the cylindrical portion to unite the tightening sheet with the main body (see Patent Document 1 listed below). In order to obtain the nut disclosed in this prior art, it is essential to perform an assembling process for bending operation after combining the main body and the tightening sheet, which are independently prepared. The unity between the main body and the tightening sheet is not so strong since the tightening sheet in a circular shape is housed in the cylindrical portion in a cylindrical shape.

### PRIOR ART DOCUMENTS

### Patent Documents

Patent Document 1: JP-A-10-169630 (in particular paragraphs 0024 and 0025)

SUMMARY OF INVENTION

### Technical Problem

It is a main object of the present invention to easily and properly unite a metal member and a ring member made of a synthetic resin (corresponding to the tightening sheet disclosed in Patent Document 1), the metal member forming a nut body of a nut having an anti-loosening function, and the ring member being housed in the metal member.

### Solution to Problem

In order to attain the above-mentioned object, the present invention provides a nut comprising a metal member including a nut body having an internally threaded portion formed therein and an extension formed on one end of the nut body so as to surround an opening of the internally threaded portion, the metal member being subjected to surface treatment; and a ring member made of a synthetic resin, having an outer peripheral portion united with an inner side of the extension and having a ring inner diameter substantially equal to a minor diameter of the internally threaded portion of the nut body, the outer peripheral portion being united with the inner side of the extension by insert-molding using the metal member as an insert; wherein the extension has at least one recess formed in an inner portion, and the outer peripheral portion of the ring member has a rotation-preventing portion fit into the at least one recess, the rotation-preventing portion being formed by the insert molding.

The ring inner diameter of the ring member is substantially equal to the minor diameter of the internally threaded portion of the nut body. When the nut is threaded on a bolt, the external thread of the bolt can forcibly fit into the ring member to stably maintain a state that the nut is threaded on the bolt at a desired position. Since the outer peripheral portion of the ring member has the rotation-preventing portion fit into the at least one recess formed in the extension, the metal member and the ring member can be firmly united, and the metal member and the ring member are rotated as one unit without play while the nut is threaded on the bolt. The ring member is united, by insert molding, with the metal member which has been subjected to surface treatment. Accordingly, in comparison with a case where a metal member is combined with a ring member independently prepared, firstly, the unity between both members is strong. Secondly, it is not necessary to perform an assembling process for combining both members. Thirdly, the surface treatment applied to the metal member is prevented from being damaged by such an assembling process. Since the surface treatment, for example, various kinds of coating treatment, such as baking finishing, or various kinds of plate processing, is performed before the ring member has been formed in the metal member by insert molding, the composition of the ring member made of the synthetic resin can be prevented from being adversely affected by such treatment. When the recess is formed so as to be outwardly open in the protruding edge of the extension, the ring member can be easily molded in the extension by utilizing the recess as a flow channel for synthetic resin melt during the insert molding. When the extension has an inner flange on the protruding edge, and when the recess is formed in the inner flange, the ring member can be firmly and continuously held in the extension when the nut is threaded on a bolt. Further, the nut body and the ring member can be prevented from being separated after the nut has been threaded on the bolt.

In accordance with the present invention, it is possible to easily and properly unite the metal member and the ring member made of a synthetic resin, the metal member forming the nut body of the nut having an anti-loosening function, and the ring member made of a synthetic resin being housed in the metal member.

### BRIEF DESCRIPTION OF DRAWINGS

In the drawings:

FIG. 1 is a plan view of the nut according to an embodiment of the present invention;

FIG. 2 is a bottom view of the nut;

FIG. 3 is a front view of the nut;

FIG. 4 is a right side view of the nut;

FIG. 5 is a cross-sectional view taken along line A-A of FIG. 1;

FIG. 6 is a cross-sectional view taken along line B-B of FIG. 1;

FIG. 7 is a cross-sectional view showing how to use the nut; and

FIG. 8 is a cross-sectional view showing an example of the mold structure for producing the nut.

### DETAILED DESCRIPTION OF INVENTION

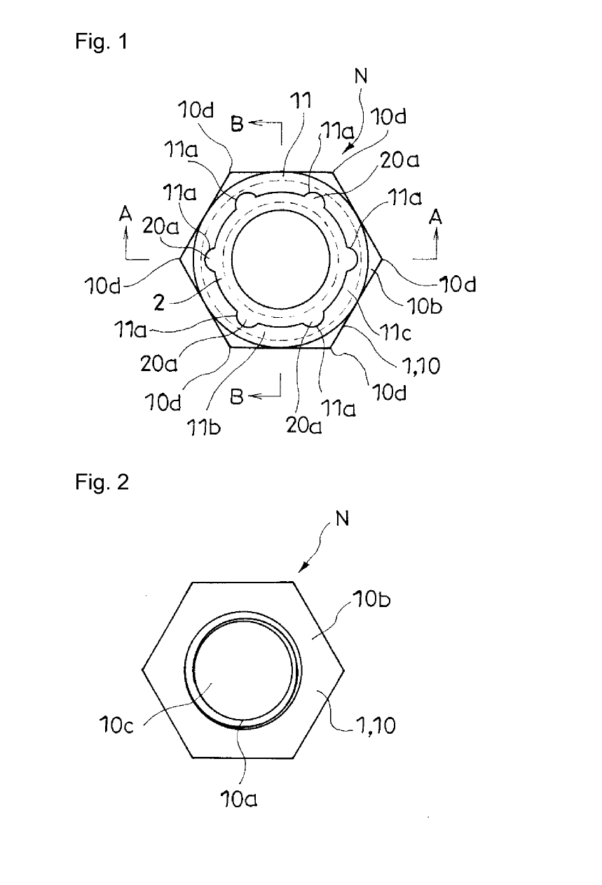

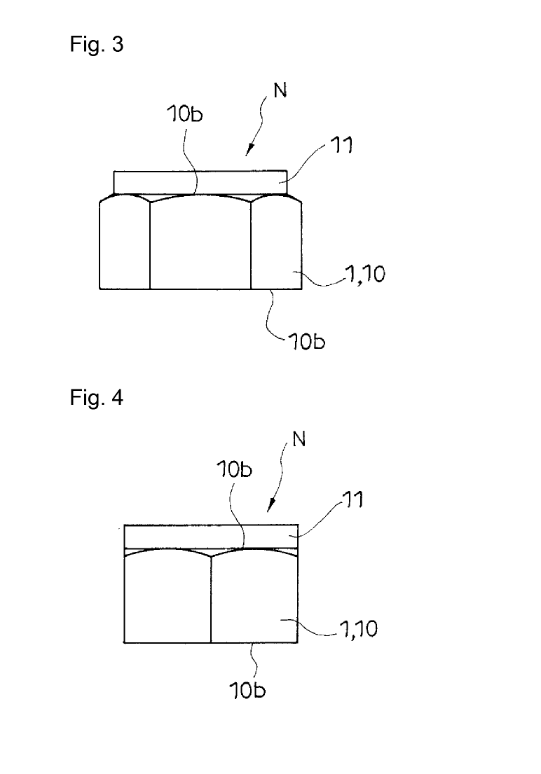

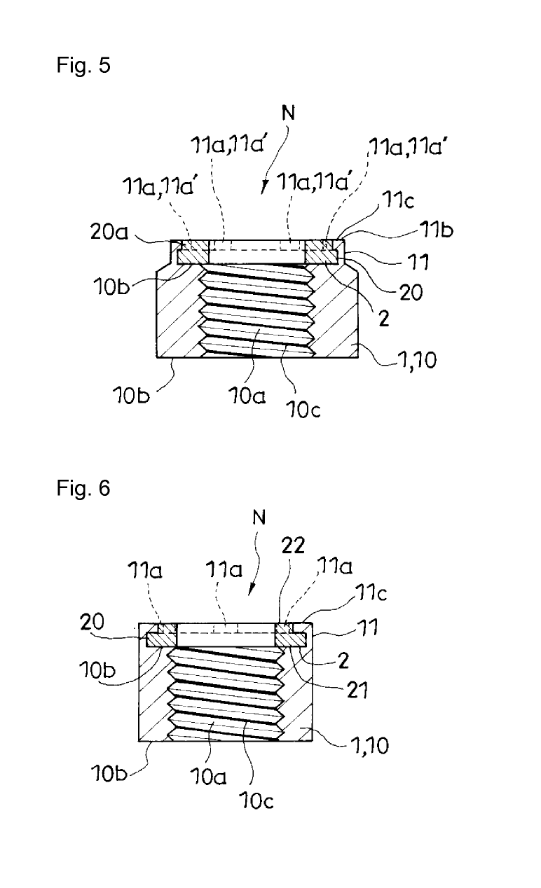

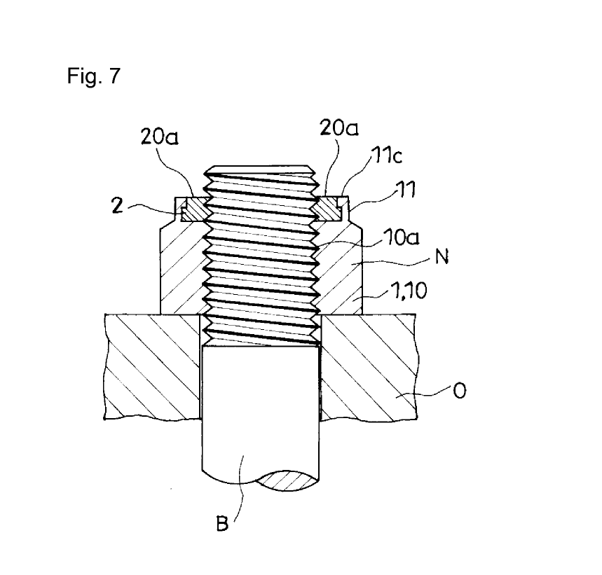

Now, a typical embodiment of the present invention will be described in reference to FIGS. 1 to 8. The nut N according the embodiment has a function of stably maintaining a state that the nut N is threaded on a bolt B, in other words, has an anti-loosening function. As shown in e.g. FIG. 7, the nut N is used for e.g. a purpose of being threaded on a protruding end of the bolt B passing through an object O so as to fasten the object O to a member (not shown), to which the bolt has a base side fixed. The nut N includes a metal member 1 and a ring member 2 made of a synthetic resin.

The metal member 1 includes a nut body 10 and an extension 11. The metal member 1 is subjected to surface treatment before performing insert molding described later. Typical examples of the surface treatment include any kinds of coating treatment, such as baking painting, and any kinds of plate processing.

The nut body 10 forms a main body of the nut N and has an internally threaded portion 10a formed therein. In the shown embodiment, the nut N is formed in a hexagonal nut shape. Specifically, in the shown embodiment, the nut body 10 has an internally threaded bore 10c formed therein so as to extend from both ends 10b and 10b. The internally threaded bore 10c forms the internally threaded portion 10a. The nut body has a hexagonal cross-sectional profile in a direction orthogonal to the bore axis of the internally threaded bore 10c. The entire length or the cross-sectional profile of the nut body 10 may be modified as required.

The extension 11 is formed so as to surround an opening of the internally threaded portion 10a on one end 10b of the nut body 10 and is integrally formed with the nut body 10. The extension 11 is formed in a peripheral wall shape surrounding the opening. In the shown embodiment, the extension 11 is formed on only one of both ends 10b and 10b of the nut body 10. In the shown embodiment, the extension 11 is formed in a short cylindrical shape so as to have one end integrally connected to the one end 10b of the nut body 10.

The extension 11 has at least one recess 11a formed in an inner portion. In the shown embodiment, the extension 11 has six recesses 11a formed in the inner portion of the extension 11 such that adjacent recesses 10a are spaced apart in a circumferential direction around the bore axis of the internally threaded bore 10c. In the shown embodiment, the respective recesses 11a are formed at positions corresponding to the respective six corners 10d of the hexagonal cross-sectional profile of the nut body 10.

In the shown embodiment, the respective recesses 11a are outwardly open in a protruding end 11b of the extension 11. The extension 11 is has an inner flange 11c on the protruding end 11b, and the recesses 11a are formed in the inner flange 11c. In the shown embodiment, the recesses 11a is constituted by grooves 11a′ which are formed in an inner portion of the inner flange 11c so as to extend along the bore axis and have a semi-arced cross-sectional shape in a width direction.

On the other hand, the ring member 2 has an outer peripheral portion 20 united with an inner side of the extension 11 by insert molding using the metal member 1 as an insert, and has a ring inner diameter substantially equal to the minor diameter of the internally threaded portion of the nut body 10. Normally, the metal member 1 is placed in a mold M for molding the ring member 2 before synthetic resin melt P for forming the ring member 2 is injected into the mold M. After the ring member 2 has been molded, the metal member 1 is taken out of the mold M in the form of the nut N with the ring member 2 according to this embodiment. By the insert molding, rotation-preventing portions 20a are formed in the outer peripheral portion 20 of the ring member 2 so as to fit into the recesses 11a formed in the extension 11.

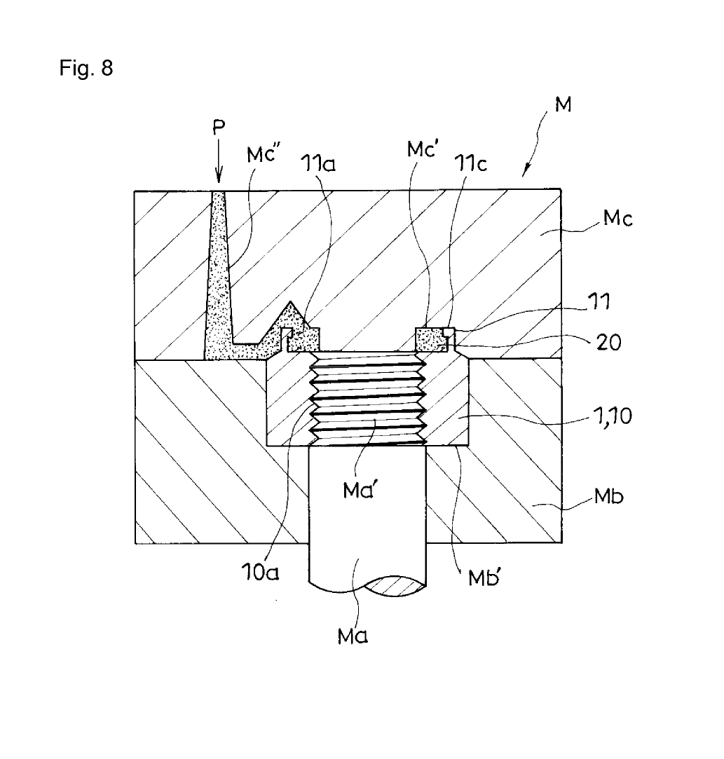

A typical example of the mold M for performing the insert molding is shown in FIG. 8. Reference symbol Ma indicates a mold forming part including an externally threaded portion Ma′ to be threaded into the metal member 1. Reference symbol Mb indicates one of paired mold halves, which has a recess Mb′ formed so as to house the nut body 10 of the metal member 1. Reference symbol Mc indicates the other mold half which has a recess Mc′ formed so as to house the extension 11 of the metal member 1 and provide an injection cavity for injecting the synthetic resin melt to form the ring member 2 in the extension, and which includes an injection channel Mc″ (a sprue, a runner and a gate). After the ring member 2 has been molded, the nut N and the mold forming part Ma are taken out of the mold M, being coupled, and the mold forming part Ma is unthreaded to be removed from the nut N.

In the shown embodiment, the ring member 2 has one end 21 brought into close contact with the end 10b of the nut body 10 and the other end 22 flush with an outer surface of the inner flange 11c of the extension 11. The ring member has six rotation-preventing portions 20a at corners where the other end 22 is brought into contact with the outer peripheral portion 20 of the ring member such that the rotation-preventing portions are formed in a projecting shape so as to be complementary to the recesses 11a. In the shown embodiment, the ring member 2 has an inner diameter equal to the minor diameter of the internally threaded portion of the nut body 10 of the metal member 1, i.e. the diameter of a circle formed by the crest of the internal thread of the threaded bore 10c forming the internally threaded portion 10a. However, it is sufficient that the inner diameter of the ring member is set to such a size that the thread of the bolt B can forcibly fit into an inner peripheral portion of the ring member 2 when the nut N is threaded on the bolt B. In other words, the inner diameter of the ring member may be slightly smaller than the minor diameter of the internally threaded portion of the nut body 10 of the metal member 1 or slightly larger than the minor diameter of the internally threaded portion of the nut body 10 of the metal member 1.

The inner diameter of the ring member 2 is substantially equal to the minor diameter of the internally threaded portion of the nut body 10. Accordingly, when the nut N is threaded on the bolt B, the external thread of the bolt B can forcibly fit into the ring member 2 with the result that it is possible to stably maintain a state that the nut N is threaded on the bolt B at a desire position (see FIG. 7). Since the rotation-preventing portions 20a are formed in the outer peripheral portion 20 of the ring member 2 so as to fit into the recesses 11a formed in the extension 11, the metal member 1 and the ring member 2 are firmly united, and the metal member 1 and the ring member 2 are rotated as one unit without play while the nut N is threaded on the bolt B. The ring member 2 is united, by insert molding, with the metal member 1 which has been subjected to surface treatment. Accordingly, in comparison with a case where the metal member 2 is combined with a ring member 2 independently prepared, firstly, the unity between both members is strong. Secondly, it is not necessary to perform an assembling process for combining both members. Thirdly, the surface treatment applied to the metal member is prevented from being damaged by such an assembling process. Since the surface treatment, for example, various kinds of coating treatment, such as baking finishing, or plate processing, is performed before the ring member 2 has been molded in the metal member 1 by the insert molding, the composition of the ring member 2 made of the synthetic resin can be prevented from being adversely affected by such treatment. In this embodiment, since the recesses 11a are formed so as to be outwardly open in the protruding edge 11b of the extension 11, the ring member 2 can be easily molded in the extension 11 by utilizing the recesses 11a as a flow channel for the synthetic resin melt P during the insert molding. Since the extension 11 has the inner flange 11c on the protruding edge 11b, and since the recesses are formed in the inner flange 11c, the ring member 2 can be firmly and continuously held in the extension 11 when the nut N is threaded on the bolt B. Further, the nut body 10 and the ring member 2 can be prevented from being separated after the nut N has been threaded on the bolt B.

The entire disclosure of Japanese Patent Application No. 2012-210428 filed on Sep. 25, 2012 including specification, claims, drawings and summary is incorporated herein by reference in its entirety.

What is claimed is:

1. A nut comprising:
a metal member including a nut body having an internally threaded portion formed therein and an extension formed on one end of the nut body so as to surround an opening of the internally threaded portion, the metal member being subjected to surface treatment; and
a ring member made of a synthetic resin, having an outer peripheral portion united with an inner side of the extension and having a ring inner diameter substantially equal to a minor diameter of the internally threaded portion of the nut body, the outer peripheral portion being united with the inner side of the extension by insert-molding using the metal member as an insert;
wherein the extension has at least one recess formed in an inner portion, and the outer peripheral portion of the ring member has a rotation-preventing portion fit into the at least one recess, the rotation-preventing portion being formed by the insert molding.

2. The nut according to claim 1, wherein the at least one recess is open in a protruding end of the extension.

3. The nut according to claim 1, wherein the extension has an inner flange on a protruding end, and the at least one recess is formed in the inner flange.
